(19) United States
(12) Patent Application Publication
(10) Pub. No.: US 2008/0062268 A1
(43) Pub. Date: Mar. 13, 2008

(54) Apparatus, Method and Program for Information Processing

(75) Inventors: Hisashi Ohara, Kanagawa (JP); Masayuki Ryuto, Kanagawa (JP)

Correspondence Address: BIRCH STEWART KOLASCH & BIRCH, PO BOX 747, FALLS CHURCH, VA, 22040-0747, US

(73) Assignee: Fujifilm Corporation, Tokyo (JP)

(21) Appl. No.: 11/793,830

(22) PCT Filed: Dec. 22, 2005
(86) PCT No.: PCT/JP05/24168

§ 371 Date: Sep. 5, 2007

(30) Foreign Application Priority Data
Dec. 24, 2004 (JP) 2004-373946

(51) Int. Cl. H04N 5/225

(52) U.S. Cl. 348/207.2; 348/E05.024

(57) ABSTRACT

A personal computer (12) executes an information processing program (38) to start a shooting process. Under the shooting process, an extraction circuit (42) reads compressed image data from a HDD (37). The extraction circuit (42) analyzes the compressed image data to extract a portion including a human face, whose focus and exposure amount is inspected by a focus judgment section (43a) and an exposure amount judgment section (43b) in a judgment circuit (43). Based on a result of the inspection, the image is judged whether it is appropriate for printing. A display color of a focus icon (65) and/or an exposure amount icon (66) is changed when any of the portions including a human face is judged to be not focused by the focus judgment section (43a) and/or is judged to be over or under exposed by the exposure amount judgment section (43b).

### TECHNICAL FIELD

The present invention relates to an information processing apparatus, an information processing method and an information processing program for an image capture system, which is utilized in a photographic studio specializing in memorial shots and commercial shots.

### BACKGROUND ART

Recently, an image capture system, which can receive a print order of images immediately after shooting, has been brought into photo studios specializing in memorial shots and commercial shots. Such image capture system has an information processing apparatus, like a personal computer, for processing the images captured by a digital camera, and a monitor for displaying the captured images and print order information of these images (see Japanese Laid-open Patent Application No. 2002-139805).

In the image capture system disclosed in the Japanese Laid-open Patent Application No. 2002-139805, correction conditions for color, hue, saturation, sharpness and the like, are predetermined for each camera, and desired pictures are obtained efficiently by automatically processing the images in accordance with these correction conditions. In the above-mentioned image capture system, a captured image frame is displayed on the monitor of the personal computer to be viewed by a customer. By reviewing the image displayed on the monitor, the customer considers whether to try another shooting.

In the photo studio, an operator inspects condition of the images (focus, exposure amount, closed eyes, face direction, etc.) displayed on the monitor during or after the shooting to judge whether the images are appropriate for printing or not. The image frames judged as appropriate for printing are then reviewed by a customer so that the customer can select the images to be printed among the image frames. A primary portion of the image, such as a human face is especially inspected carefully by zooming in on the primary portion, since it affects the quality of produced prints.

In order to display the primary portion enlarged, however, the operator has to manipulate a keyboard or a mouse of the personal computer. Therefore, it is very burdensome to inspect the condition of the images during the shooting. In a case where the operator inspects the condition of the images consecutively after completing the shooting, the operator has to conduct additional shooting if there is no image frame appropriate for printing. Therefore, work efficiency is reduced in either case.

In addition, different operators have different standards for judging whether the image frames are appropriate for printing or not. Therefore, there is a potential that inappropriate image frames are printed when an inexperienced operator judges the condition of the images.

In view of the foregoing, an object of the present invention is to provide an information processing apparatus, an information processing method and an information processing program that improve work efficiency in photo studios.

Another object of the present invention is to provide an information processing apparatus, an information processing method and an information processing program that enable an accurate judgment whether the images are appropriate for printing or not.

### DISCLOSURE OF INVENTION

In order to achieve the above and other objects, an information processing apparatus of the present invention includes an extractor, a judgment device, an indicator and an indication controller. The extractor extracts a primary portion from a captured image after analyzing image data obtained by shooting. The judgment device judges whether the image is appropriate for printing based on a result obtained by inspecting condition of the primary portion. The indicator indicates a judgment result given by the judgment device. The indication controller controls the indicator to indicate the judgment result.

A first mark representing an item of the condition to be inspected is indicated on the indicator, and a form of the first mark is changed on the indicator according to the judgment result. Additionally, a second mark representing a position of the primary portion in the image is indicated on the indicator, and a form of the second mark is changed on the indicator according to the judgment result.

In another embodiment, a second mark is indicated when the first mark is designated. A form of the second mark is changed on the indicator according to the judgment result.

In a preferable embodiment of the present invention, the image frame and a third mark representing the judgment result are displayed simultaneously on the indicator.

It is preferable that the indicator is a monitor. The judgment device inspects focus and an exposure amount of the primary portion. The extractor extracts a portion including a human face as the primary portion.

An information processing method of the present invention includes the steps of extracting, judging and indicating. The extracting step extracts a primary portion from a captured image after analyzing image data obtained by shooting. The judging step judges whether the image is appropriate for printing based on a result obtained by inspecting condition of the primary portion. The indicating step indicates a judgment result given by the judgment device.

An information processing program of the present invention enables a personal computer to perform the steps of extracting, judging and indicating. The extracting step extracts a primary portion from a captured image after analyzing image data obtained by shooting. The judging step judges whether the image is appropriate for printing based on a result obtained by inspecting condition of the primary portion. The indicating step indicates a judgment result given by the judgment device.

According to the information processing apparatus, method and program of the present invention, the primary portion is extracted and its condition is inspected. Based on a result of the inspection, it is judged whether the image frame is appropriate for printing or not, and its judgment result is indicated. For this configuration, the judgment result can be confirmed during the shooting. Owing to this, a complicated job, such as manipulating the key board or the mouse of the personal computer for enlarging the primary portion, is unnecessary. In addition to it, necessity of performing additional shooting can be reduced. Therefore, work efficiency in photo studios is improved. Moreover, the quality of the produced prints is also improved since the image frames are judged on a fixed standard as to whether they are appropriate for printing.

### BRIEF DESCRIPTION OF DRAWINGS

FIG. 1 is a schematic diagram showing a structure of an image capture system including a personal computer to which the present invention is applied;

FIG. 2 is a block diagram showing a structure of a digital camera;

FIG. 3 is a block diagram showing a structure of the personal computer;

FIG. 4 is an explanatory view showing a customer management window displayed on a monitor of the personal computer;

FIG. 5 is an explanatory view showing a picture window displayed on the monitor of the personal computer;

FIG. 6 is an explanatory view showing the picture window with boxes to indicate positions of primary portions;

FIG. 7 is a flow chart showing a procedure of an information processing of the present invention; and

FIG. 8 is an explanatory view showing an example where thumbnail images and symbols of judgment result are displayed.

### BEST MODE FOR CARRYING OUT THE INVENTION

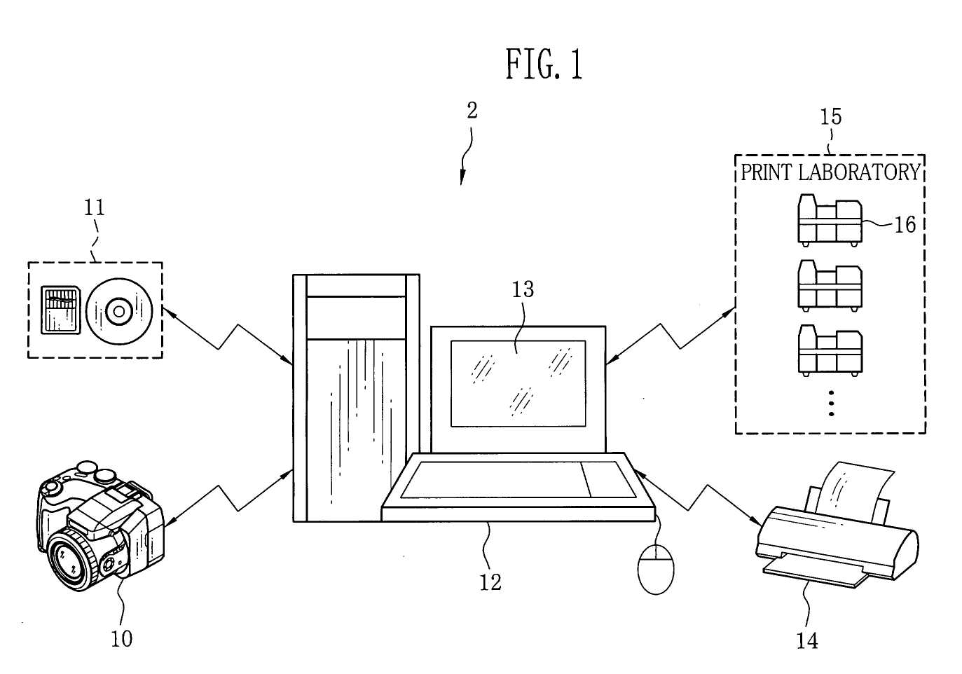

In FIG. 1, an image capture system 2 is provided in photo studios specializing in memorial shots like wedding shots, and commercial shots. The image capture system 2 imports image data obtained with a digital camera 10, or image data recorded in a recording medium 11, such as a memory card or CD-R, into a personal computer (hereinafter, abbreviated as PC) 12 as an information processing apparatus and displays images on a monitor 13 of the PC 12 to receive a print order of the images. The image data recorded in the recording medium 11 includes images on photo films digitized into TIFF or JPEG format. The image capture system 2 then produces prints according to the print order, by a printer 14 equipped in the photo studio or by laboratory printers 16 equipped in a laboratory 15.

The digital camera 10, the printer 14 and the laboratory printers 16 are connected to the PC 12 through, for instance, a communication cable compliant with IEEE 1394 or USB (Universal Serial Bus), a wireless LAN or the like, and communicate data with the PC 12 mutually. The recording medium 11 exchanges data with the PC 12 through a specific driver.

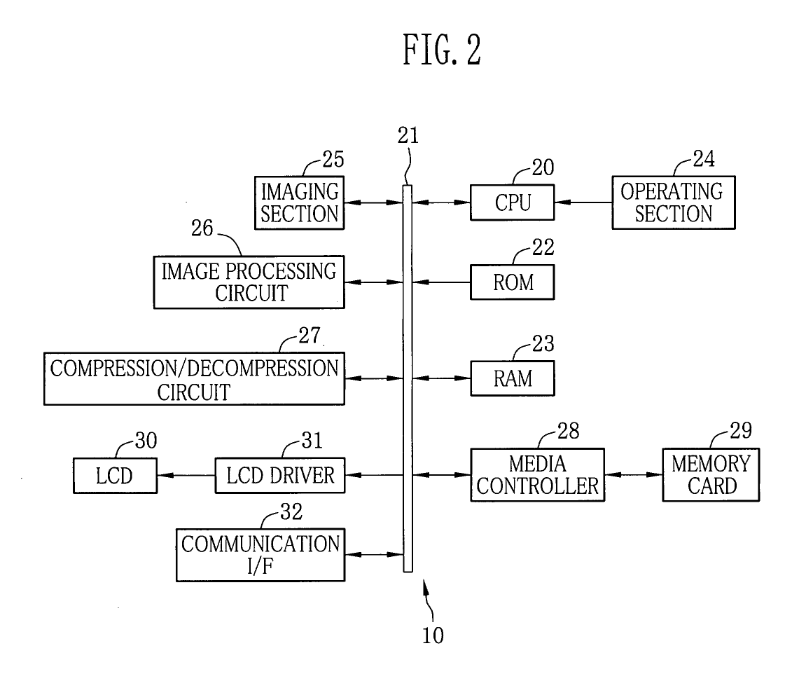

In FIG. 2, a CPU 20 is connected to all components of the digital camera 10 through a data bus 21, and comprehensively controls operations of the digital camera 10. A ROM 22 stores various programs and data necessary for the operation of the digital camera 10. The CPU 20 reads the programs and data from the ROM 22 to execute various processing. The CPU 20 operates every component of the digital camera 10 in accordance with operations of an operating section 24. The operating section 24 is constituted of a shutter release button and set-up buttons to set up f-number, shutter speed, zoom magnification, ISO sensitivity and the like.

An imaging section 25 is provided with a well-known taking lens, CCD and A/D converter. The imaging section 25 performs photoelectric conversion of an optical image of a subject formed by the taking lens by use of the CCD. An image signal is then converted into image data and is outputted. The image data outputted from the imaging section 25 is temporarily stored in a RAM 23. The image data is raw image data (CCD RAW data) before going through image processing like white-balance correction and the like. One pixel is constituted of RGB data, and each color data is represented by 12 bits.

An image processing circuit 26 reads the raw image data from the RAM 23 to convert the 12-bit pixel data of each color into 8-bit pixel data, and applies thereto the white-balance correction, γ correction and YC conversion to output original image data. The image processing circuit 26 thins out pixels of the original image data to produce reduced image data (hereinafter, referred to as thumbnail image data) of, for instance, 1280×960 pixels.

A compression/decompression circuit 27 compresses the image data of the original image and the thumbnail image according to JPEG format. The image data compressed by the compression/decompression circuit 27 is once written into the RAM 23, and then is recorded in a memory card 29 by a media controller 28.

Under the control of a LCD driver 31, an LCD 30 displays through images of subjects continuously during the shooting, or reproduces the images which are read from the memory card 29 and displays the reproduced images. A communication interface (I/F) 32 sends the raw image data outputted from the imaging section 25, the image data of the original image and the thumbnail image compressed by the compression/decompression circuit 27 (hereinafter, referred to as compressed image data) to the PC 12 via the above mentioned communication cable or the wireless LAN.

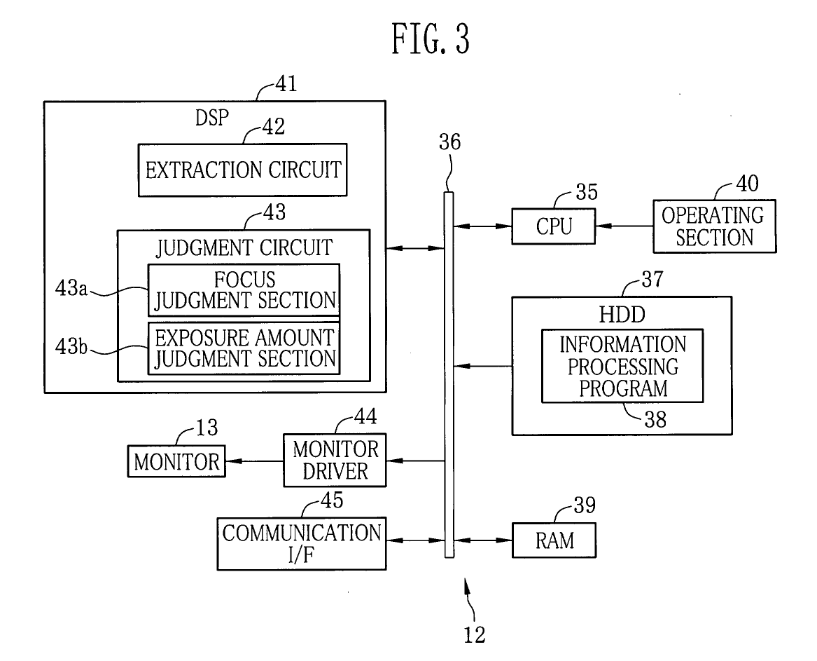

In FIG. 3, a CPU 35 is connected to all components of the PC 12 through a data bus 36, and comprehensively controls operations of the PC 12. A hard disk drive (HDD) 37 stores an information processing program (hereinafter, referred merely to as program) 38 as well as various programs and data necessary for the operation of the PC 12. The data stored in the HDD 37 includes the image data sent from the digital camera 10 and customer management data which is stored in connection with the image data. The customer management data contains personal information of customers, print order information and the like.

The program 38 allows the PC 12 to execute all processes of shooting with the digital camera 10, importing image data from the recording medium 11, presenting images to a customer for selection of the images to be printed, performing color correction, gradation correction or the like onto the image data, receiving the print order, sending it to the laboratory and producing an index print to check produced prints. The program 38 is recorded in the recording medium 11, such as CD-ROM, DVD-ROM, or the like, and is previously installed in the HDD 37 from the recording medium 11.

The CPU 35 loads the programs and data from the HDD 37 into a RAM 39, which is a work memory, to execute various processing. The CPU 35 operates every component of the PC 12 in accordance with directions inputted from an operating section 40 constituted of a keyboard and a mouse.

A DSP (digital signal processor) 41 reads out the compressed image data stored in the HDD 37. The DSP 41 decompresses the image data and executes various image processing thereto. The DSP 41 has function of an extraction circuit 42 and a judgment circuit 43.

The extraction circuit 42 extracts a primary portion of the image, such as a portion including a human face or an animal head, or a specific commodity and so forth, by analyzing the decompressed image data read from the HDD 37. As an extraction method, the well-known pattern recognition technique, in which frequency response, hue component, or the like is analyzed to extract a desired portion from the image, is utilized. The primary portion to be extracted may be selectively changed. Hereinafter, the present embodiment is explained in a case where a human face is specified as the primary portion.

The judgment circuit 43 is provided with a focus judgment section 43a and an exposure amount judgment section 43b. The focus judgment section 43a inspects focus of the portion including a face extracted by the extraction circuit 42. The exposure amount judgment section 43b insects an exposure amount of the same. Based on a result of the inspection of the focus and the exposure amount, the focus judgment section 43a and the exposure amount judgment section 43b judge whether the image is appropriate for printing.

The focus judgment section 43a acquires, for instance, a spatial frequency response of the image data of the portion including a face. The focus judgment section 43a then compares it with a predetermined threshold value. When the acquired frequency response is lower than the threshold value, the focus judgment section 43a judges that the portion including a face is not focused.

Meanwhile, the exposure amount judgment section 43b refers to, for instance, a brightness value of the portion including a face and shutter speed and f-number added to the image data, thereby acquiring the exposure amount of the portion including a face. Then, the exposure amount judgment section 43b compares the acquired exposure amount with predetermined upper and lower limit values. When the acquired exposure amount is higher than the upper limit value, the exposure amount judgment section 43b judges that the portion including a face is over exposed. When the acquired exposure amount is lower than the lower limit value, the exposure amount judgment section 43b judges that the portion including a face is under exposed.

When a plurality of faces exists in a single image, like a group shot, the extraction circuit 42 extracts all of the faces. In this case, the judgment circuit 43 performs the judgment on all of the faces extracted by the extraction circuit 42.

The image data of the portion including a face extracted by the extraction circuit 42 and a judgment result given by the judgment circuit 43 are made associated with the compressed image data, by use of a filename or the like, and recorded in the HDD 37.

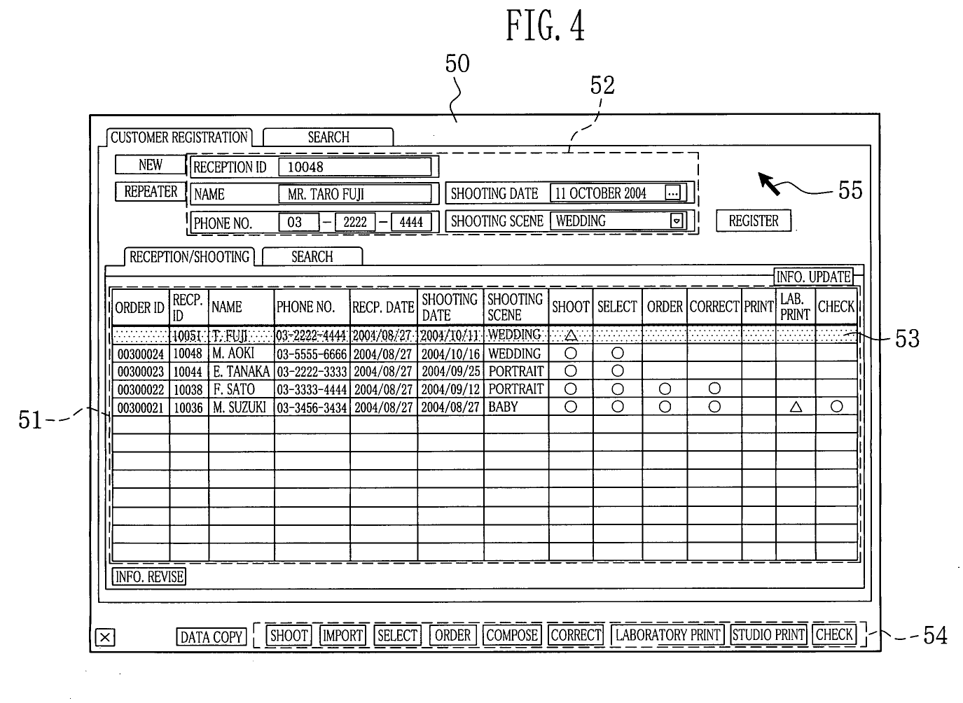

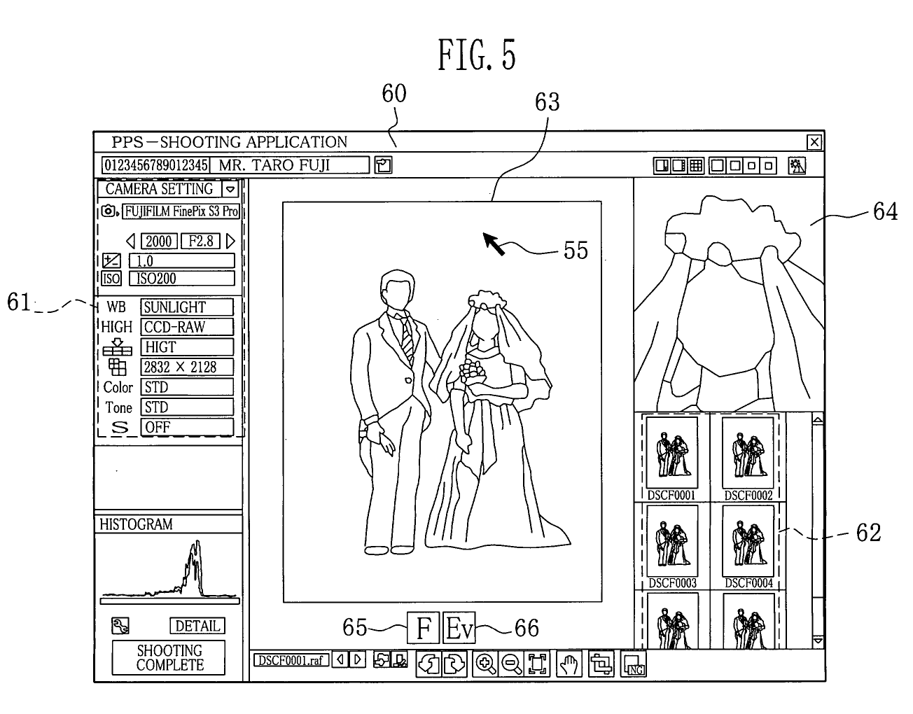

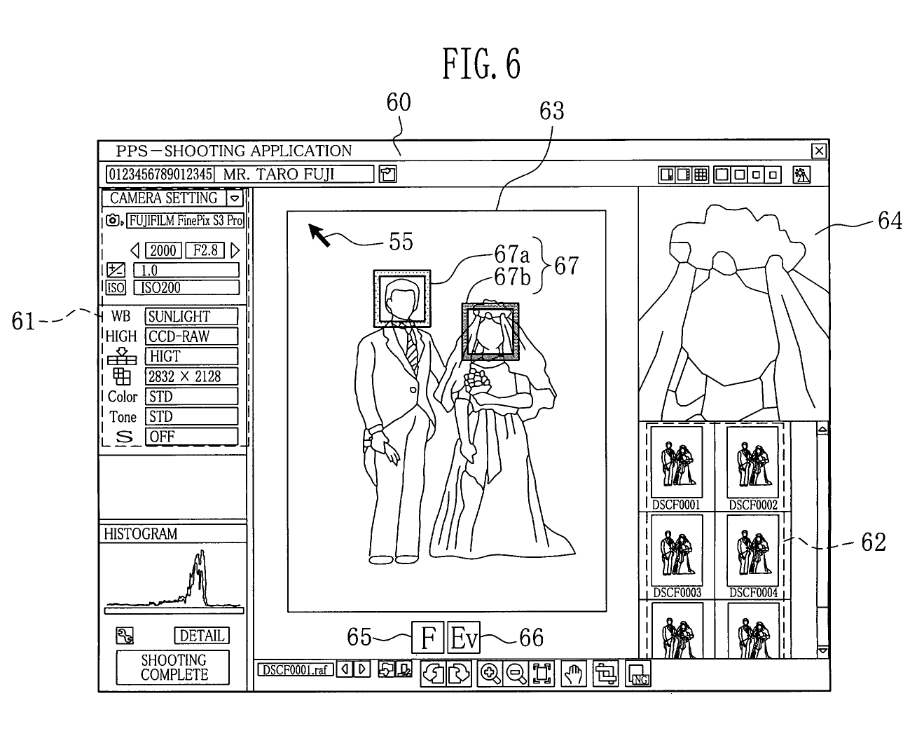

The monitor 13 displays a customer management window 50 (see FIG. 4) or a picture window 60 (see FIGS. 5 and 6) under the control of a monitor driver 44. These windows 50 and 60 are described later in detail. A communication I/F 45 receives the image data from the digital camera 10 or the recording medium 11, and transmits a command for printing to the printer 14 or the laboratory printers 16.

When the program 38 is started up in accordance with the operation of the operating section 40, the monitor 13 displays the customer management window 50, as shown in FIG. 4. On the customer management window 50, registration of new customers, correction or deletion of the registered information, search of the registered customers are performed in accordance with the operational directions inputted from the operating section 40. The customer management window 50 has a list 51 displays a shooting date, a shooting scene (wedding, baby, etc.), progress of each process as well as personal information of customers (order ID, reception ID, name and phone number) of the image capture system 2. In the upper area of the customer management window 50, information 52 of the selected customer is shown. The selected customer is shown distinct from the other customers by a cursor 53 (shown by hatching) on the list 51.

In the lower area of the customer management window 50, buttons 54 (“SHOOT”, “IMPORT”, “SELECT”, “ORDER”, “COMPOSE”, “CORRECT”, “LABORATORY PRINT”, “STUDIO PRINT” and “CHECK” buttons) are provided. Placing a pointer 55 onto one of these buttons and clicking the mouse will lead to shift to the corresponding process and the monitor 13 displays the window specific for the corresponding process.

When the “SHOOT” button is selected, a shooting process starts for assisting the shooting by the digital camera 10. Upon starting the shooting process, the extraction circuit 42 and the judgment circuit 43 of the DSP 41 are activated. Additionally, the monitor 13 displays the picture window 60, as shown in FIG. 5. The picture window 60 displays shooting parameter information 61, such as the ISO sensitivity and the f-number, of the digital camera 10, a list 62 of the thumbnail images, a whole of the image (hereinafter, referred to as whole image) 63 created from the original image and an image of the portion including a face (hereinafter, referred to as partial image) 64, which is extracted by the extraction circuit 42. When a plurality of faces exists in the whole image 63, as shown in the drawing, the portion including a face to be displayed as the partial image 64 is selected by, for instance, clicking the pointer 55 on the desired face.

As a set of first marks, focus and exposure amount icons 65 and 66 indicating the judgment result of the focus judgment section 43a and the exposure amount section 43b are provided below the whole image 63. These icons 65 and 66 are normally displayed in green. A display color of the focus icon 65 is changed from green to red when any one of the portions including a face in the whole image 63 is judged to be not focused by the focus judgment section 43a. In the same manner, a display color of the exposure amount icon 65 is changed from green to red when any one of the portions including a face in the whole image 63 is judged to be over or under exposed by the exposure amount judgment section 43b.

As shown in FIG. 6, upon clicking on each icon 65 or 66, a rectangular box (second mark) 67 surrounding the portion including a face is overlaid on the displayed whole image 63. The number of the displayed box 67 corresponds to that of the displayed faces. The box 67 is normally displayed in green. A display color of the box 67 is changed from green to red when the portion including a face that is surrounded by the box 67 is judged to be not focused by the focus judgment section 43a, or judged to be over or under exposed by the exposure amount judgment section 43b. In the present embodiment, a box 67a is displayed in green and a box 67b is displayed in red. Owing to this configuration, the corresponding portion including a face can be confirmed immediately by clicking the icon 65 or 66 when it turns to red. Note that the display of the box 67 can be canceled by clicking on each of the icons 65 and 66.

Referring back to FIG. 4, when the “IMPORT” button is selected, an importing process starts. Under the importing process, the image data is imported from the recording medium 11 and is stored in the HDD 37. When the “SELECT” button is selected, a selecting process starts. Under the selecting process, the images are displayed on the monitor 13 as preview images, and the images to be printed are selected by the customer.

When the “ORDER” button is selected, an ordering process starts. Under the ordering process, print size and print number of the images selected under the selecting process are entered. When the “COMPOSE” button is selected, a composing process starts. Under the composing process, each of the selected images is arranged in a predetermined layout frame and an original photo album is produced. When the “CORRECT” button is selected, a correcting process starts. Under the correcting process, color correction, gradation correction or the like is performed on the image data so that the finished prints have the quality recommended by the photo studio provided with the image capture system 2.

When the “LABORATORY PRINT” button is selected, a laboratory printing process starts. Under the laboratory printing process, an order to print the images selected under the selecting process in the size and number set under the ordering process is placed to the laboratory printers 16 of the laboratory 15. When the “STUDIO PRINT” button is selected, a studio printing process starts. Under the studio printing process, the print order is placed to the printer 14. When the “CHECK” button is selected, a checking process starts. Under the checking process, an index print is produced for checking prints when the prints produced by the laboratory printers 16 of the laboratory 15 are delivered.

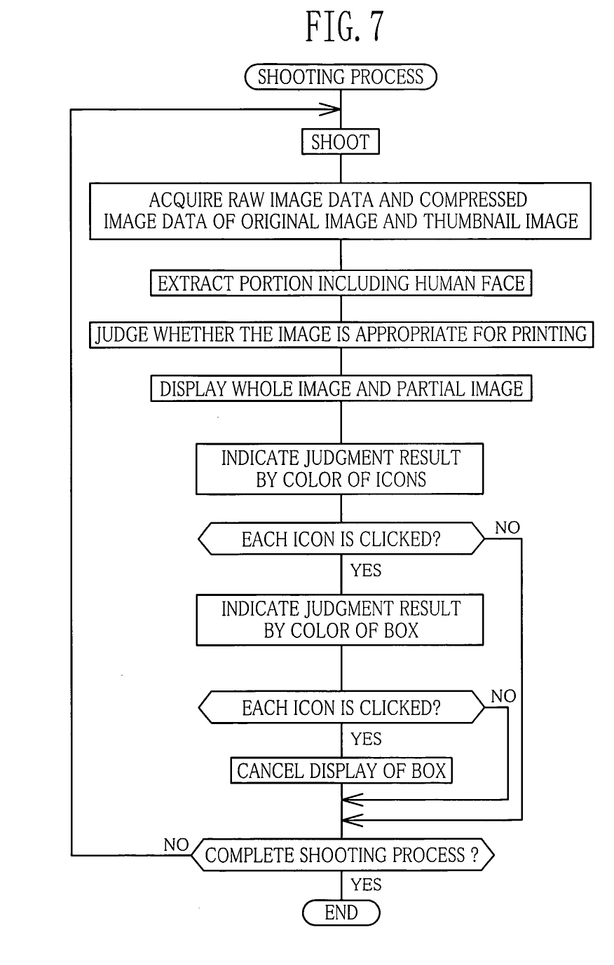

Next, a procedure of the information processing by the PC 12 is explained with referring to the flow chart shown in FIG. 7. Firstly, the operating section 40 is operated for starting up the program 38 to display the customer management window 50 on the monitor 13. On the customer management window 50, the registration of new customers, correction or deletion of the registered information, search of the registered customers are performed.

When the “SHOOT” button is selected to start the shooting process, the extraction circuit 42 and the judgment circuit 43 of the DSP 41 are activated. Additionally, the monitor 13 switches the display from the customer management window 50 to the picture window 60. When the shooting with the digital camera. 10 is performed, the raw image data, the compressed image data of the original image and the thumbnail image are produced and recorded in the memory card 29. These data recorded in the memory card 29 is outputted from the communication I/F 32 and is recorded in the HDD 37 via the communication I/F 45.

The compressed image data is once stored in the HDD 37, and then is read out by the extraction circuit 42 to be decompressed. The extraction circuit 42 extracts the portion including a face in the image by analyzing the decompressed image data. The portion including a face extracted by the extraction circuit 42 is sent to the judgment circuit 43.

In the judgment circuit 43, the focus judgment section 43a inspects the focus of the portion including a face, whereas the exposure amount judgment section 43b inspects the exposure amount of the same. Based on the result of the inspection, the focus judgment section 43a and the exposure amount judgment section 43b judge whether the image is appropriate for printing. The image data including a face and the judgment result are made associated with the compressed image data and recorded in the HDD 37.

The compressed image data is read from the HDD 37 to the monitor driver 44 to be decompressed. Then, the whole image 63 and the partial image 64 are displayed on the picture window 60. When any one of the portions including a face in the whole image 63 is judged to be not focused by the focus judgment section 43a, or is judged to be over or under exposed by the exposure amount judgment section 43b, the display color of the focus icon 65 and/or the exposure amount icon 66 is changed from green to red.

Upon clicking on each icon 65 or 66, the box 67 representing a position of the portion including a face in the whole image 63 is displayed. The box 67, which surrounds the portion including a face judged to be not focused by the focus judgment section 43a, or judged to be over or under exposed by the exposure amount judgment section 43b, is displayed in red. The display of the box 67 is canceled by reclicking on the icon 65 or 66. The information processing procedure is repeated until the executed process shifts from the shooting process to another or until the program 43 is completed.

When the shooting with the digital camera 10 is completed, each process is selected to be executed. Then, the prints according to the print order from the customer are produced by the printer 14 or by the laboratory printers 16. The produced prints are handed to the customer after the payment is made.

In the PC 12, the portion including a face is extracted by the extraction circuit 42 after analyzing the image data obtained by shooting. Then, it is judged whether the image is appropriate for printing or not by the judgment circuit 43, and its judgment result is indicated to the operator by changing the display color of the icons 65 and 66. For this configuration, the operator can confirm the judgment result during the shooting. Additionally, the judgment whether the image is appropriate or not is performed by the judgment circuit 43, therefore the judgment can be made on a fixed standard.

Moreover, the judgment result is indicated by changing the display color of the box 67 representing the position of the portion including a face. For this configuration, the corresponding portion including a face can be confirmed immediately.

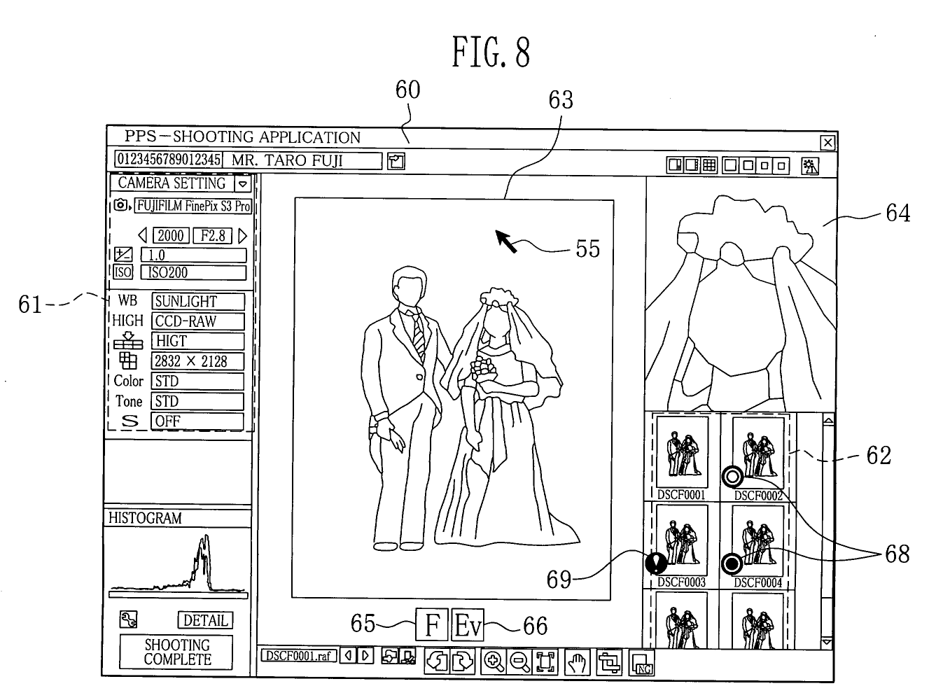

Note that symbols 68 and 69 (a set of third marks) indicating the judgment result of the judgment circuit 43 can be overlaid and displayed on the thumbnail images in the list 62, as shown in FIG. 8. The display of these symbols is performed by reading the judgment result associated with the image data of the respective thumbnail image from the HDD 37 to the monitor driver 44. In FIG. 8, the symbol 68 of “◯” is assigned to the thumbnail image judged to be appropriate for printing by the judgment circuit 43, whereas the symbol 69 of “!” is assigned to the one judged to be inappropriate. Since the symbols 68 and 69 are assigned to the thumbnail images of the list 62, the operator can tell at a glance which image should be used to check the condition. Owing to this, work efficiency can be improved. Note that the symbols 68 and 69 are not limited to “◯” and “!”, but any symbol that allows the intuitive confirmation of the judgment result may serve.

In the above embodiment, the focus and the exposure amount are specified as the items inspected by the judgment circuit 43. However, other items, such as color balance and contrast of the image, closed eyes, face direction and so forth may be included. As the method for extracting the portion of eyes (pupils) from a human face, a technique of detecting light and dark patterns representing eyes by filtering process, which is disclosed in the Japanese Laid-open Patent Application No. 2003-187257, may be utilized.

In the above embodiment, the judgment result is indicated by changing the display color of the icons 65 and 66 on the monitor 13. The judgment result may be alternatively indicated by blinking the icons 65 and 66 or by displaying a pop-up window for indicating the judgment result. Moreover, the judgment result may be indicated by voice announcement with use of a speaker, or by using a lamp or a vibrator.

Moreover, when the image is judged to be inappropriate for printing, methods for improving the condition of the image may be shown so that the operator can appropriately modify the settings of the digital camera or light fixtures for additional shooting. Specifically, when the image is judged to be not focused by the focus judgment section 43a, a direction to set the f-number higher (to increase the depth of field) may be indicated. When the image is judged to be under exposed by the exposure amount judgment section 43b, a direction to set the f-number lower may be indicated. Based on the result of the inspection of the image condition (image quality), an optimum value may be indicated.

In the above embodiment, the box 67 is utilized as the second mark. The second mark is not limited to this, but may be of any form that can indicate the position of the primary portion. For instance, a similar symbol as the symbol 68 or 69 may be utilized.

In the above embodiment, the DSP 41 works as the extraction circuit 42 and the judgment circuit 43 upon starting up the program 43. The extraction circuit 42 and the judgment circuit 43 can be implemented as a FPGA (field programmable gate array) or a discrete circuit.

Note that the monitor 13 may be constituted of a touch panel for convenient operation. For this configuration, the customer can perform various selecting operations by touching the screen of the monitor 13.

There are no particular regulations for the display size of the partial image 64, however, its display size is preferably determined in view of the display size of the whole image 63, and the viewability.

In the above embodiment, the whole image (image frame) 63, the partial image 64 and the icons 65 and 66 are displayed together only during the shooting process. However, the partial image 64 and the icons 65 and 66 may be displayed in other processes, such as the importing process, the selecting process, or the like.

### INDUSTRIAL APPLICABILITY

The information processing apparatus, information processing method and information processing program of the present invention is suitable for an image capture system, which is utilized in photo studios specializing in memorial shots and commercial shots.

1. An information processing apparatus for receiving a print order of an image displayed on a monitor, said image being captured by a digital camera and being stored in a memory as image data, said information processing apparatus comprising:
an extractor for extracting a primary portion from said image after analyzing said image data;
a judgment device for judging whether said image is appropriate for printing based on a result obtained by inspecting condition of said primary portion;
an indicator for indicating a judgment result given by said judgment device; and
an indication controller for controlling said indicator to indicate said judgment result.

2. An information processing apparatus described in claim 1, wherein said indication controller indicates on said indicator a first mark representing an item of said condition to be inspected.

3. An information processing apparatus described in claim 2, wherein said indication controller changes a form of said first mark on said indicator according to said judgment result.

4. An information processing apparatus described in claim 1, wherein said indication controller indicates on said indicator a second mark representing a position of said primary portion in said image and changes a form of said second mark on said indicator according to said judgment result.

5. An information processing apparatus described in claim 2, further comprising:
a designator for designating said first mark, wherein said indication controller indicates on said indicator a second mark representing a position of said primary portion in said image when said first mark is designated, and changes a form of said second mark on said indicator according to said judgment result.

6. An information processing apparatus described in claim 1, wherein said indication controller indicates said image and a third mark representing said judgment result simultaneously on said indicator.

7. An information processing apparatus described in claim 1, wherein said indicator is said monitor.

8. An information processing apparatus described in claim 1, wherein said judgment device inspects focus of said primary portion.

9. An information processing apparatus described in claim 1, wherein said judgment device inspects an exposure amount of said primary portion.

10. An information processing apparatus described in claim 1, wherein said extractor extracts a portion including a human face as said primary portion.

11. An information processing method for receiving a print order of an image displayed on a monitor, said image being captured by a digital camera and being stored in a memory as image data, said information processing method comprising the steps of:
extracting a primary portion from said image after analyzing said image data;
judging whether said image is appropriate for printing based on a result obtained by inspecting condition of said primary portion; and
indicating a judgment result given by said judgment step.

12. An information processing method described in claim 11, wherein said indicating step indicates a first mark representing an item of said condition to be inspected.

13. An information processing method described in claim 12, wherein said indicating step changes a form of said first mark according to said judgment result.

14. An information processing method described in claim 11, wherein said indicating step indicates a second mark representing a position of said primary portion in said image and changes a form of said second mark according to said judgment result.

15. An information processing method described in claim 12, further comprising the step of:
designating said first mark, wherein said indicating step indicates a second mark representing a position of said primary portion in said image when said first mark is designated, and changes a form of said second mark according to said judgment result.

16. An information processing method described in claim 11, wherein said indicating step indicates said image and a third mark representing said judgment result simultaneously.

17. An information processing method described in claim 11, wherein said indicating step indicates said judgment result on said monitor.

18. An information processing method described in claim 11, wherein said judging step inspects focus of said primary portion.

19. An information processing method described in claim 11, wherein said judging step inspects an exposure amount of said primary portion.

20. An information processing method described in claim 11, wherein said extracting step extracts a portion including a human face as said primary portion.

21. An information processing program for enabling a personal computer to receive a print order of an image displayed on a monitor, said image being captured by a digital camera and being stored in a memory as image data, said information processing program comprising the steps of:
extracting a primary portion from said image after analyzing said image data;
judging whether said image is appropriate for printing based on a result obtained by inspecting condition of said primary portion; and
indicating a judgment result given by said judgment step.

22. An information processing program described in claim 21, wherein said indicating step indicates a first mark representing an item of said condition to be inspected.

23. An information processing program described in claim 22, wherein said indicating step changes a form of said first mark according to said judgment result.

24. An information processing program described in claim 21, wherein said indicating step indicates a second mark representing a position of said primary portion in said image and changes a form of said second mark according to said judgment result.

25. An information processing program described in claim 22, further comprising the step of:
designating said first mark, wherein said indicating step indicates a second mark representing a position of said primary portion in said image when said first mark is designated, and changes a form of said second mark according to said judgment result.

26. An information processing program described in claim 21, wherein said indicating step indicates said image and a third mark representing said judgment result simultaneously.

27. An information processing program described in claim 21, wherein said indicating step indicates said judgment result on said monitor.

28. An information processing program described in claim 21, wherein said judging step inspects focus of said primary portion.

29. An information processing program described in claim 21, wherein said judging step inspects an exposure amount of said primary portion.

30. An information processing program described in claim 21, wherein said extracting step extracts a portion including a human face as said primary portion.
